(19) United States
(12) Patent Application Publication
(10) Pub. No.: US 2011/0114610 A1
(43) Pub. Date: May 19, 2011

(54) Controlling Slag Adhesion When Piercing a Workpiece With a Laser Beam

(75) Inventors: Arnd Szelagowski, Kirchheim unter Teck (DE); Florian Sepp, Altenstadt (DE); Mathias Schlotter, Korntal-Muenchingen (DE)

(73) Assignee: TRUMPF WERKZEUGMASCHINEN GMBH + CO. KG, Ditzingen (DE)

(21) Appl. No.: 12/971,427

(22) Filed: Dec. 17, 2010

Related U.S. Application Data
(63) Continuation of application No. PCT/EP2009/004347, filed on Jun. 17, 2009.

(30) Foreign Application Priority Data
Jun. 25, 2008 (DE) 102008030079

(51) Int. Cl. B23K 26/38

(52) U.S. Cl. 219/121.71; 219/121.7

(57) ABSTRACT

Piercing a workpiece with a laser beam, while directing multiple gas flows onto the workpiece at angles and locations that cause the gas flows to blow slag away from the piercing location and produce a gas cushion between the blown away slag and the workpiece, thereby reducing adhesion of slag. A laser processing head is accordingly configured with additional gas nozzles.

### CROSS-REFERENCE TO RELATED APPLICATIONS

This application is a continuation of, and claims priority under 35 U.S.C. §120 from, PCT/EP2009/004347, filed on Jun. 17, 2009, and designating the U.S., which claims priority under 35 U.S.C. §119 to German Patent Application No. 10 2008 030 079, filed on Jun. 25, 2008. The contents of the prior applications are hereby incorporated by reference in their entirety.

### TECHNICAL FIELD

The present invention relates to a method of piercing a workpiece with a laser beam, and a laser processing head configured to carry out the method.

### BACKGROUND

During a laser cutting operation, during piercing of thick metal sheets, there are produced, in the region of the piercing hole, accumulations of slag whose dimensions significantly increase as the metal sheet becomes thicker. In particular when processing metal sheets with a material thickness of above 30 mm, there are significant accumulations of slag. These are disruptive in particular in internal geometries which are to be cut and in small components. Furthermore, the distance sensor system of the laser processing head recognizes these accumulations as a disruptive contour and adjusts the laser processing head away from the workpiece which results in significant technical procedural problems. In order to prevent these problems, it is necessary to reduce the accumulations of slag which adhere to the workpiece.

### SUMMARY

One aspect of the invention features a method for reducing the adhesion of slag when a laser beam pierces a workpiece. At least a first gas flow is directed onto the workpiece at a first angle relative to the laser beam direction and strikes the workpiece at a first side of a piercing location and/or at the piercing location itself in order to blow the slag away from the piercing location. A second gas flow is directed onto the workpiece at a second angle relative to the laser beam, striking the workpiece at a position spaced from the piercing location and oriented at an angle relative to the first gas flow with respect to a plane perpendicular to the laser beam. The second gas flow produces a gas cushion between the workpiece and slag blown away from the piercing location by the first gas flow.

Another aspect of the invention features a laser processing head for carrying out the above method. The laser processing head has a laser cutting nozzle, through the opening of which a laser beam and a cutting gas are directed onto a piercing location on a workpiece during the piercing operation, and at least a first gas nozzle, which is arranged at a first side of the laser cutting nozzle and which is orientated at a first angle relative to the laser beam axis in order to produce a first additional gas flow, which strikes the workpiece at the first side of the piercing location and/or at the piercing location itself, in order to blow the slag away from the piercing location. The laser processing head also has at least one other gas nozzle, through which a second additional gas flow is directed onto the workpiece at a second angle relative to the laser beam axis, to strike the workpiece remote from the piercing location at a second side of the piercing location opposite the first side. The second gas flow is oriented at an angle, that is to say, in a non-parallel or anti-parallel manner, relative to the first gas flow with respect to a plane perpendicular relative to the laser beam direction, and produces a gas cushion between the slag blown away by the first gas flow and the workpiece.

The second gas flow is preferably oriented at an angle of between 30° and 135°, particularly preferred between 45° and 100°, relative to the first gas flow. In a particularly preferred manner, the second gas flow therefore does not have any or only a small flow component which is directed in the direction of the first gas flow, so that build-up of the slag in the region of the piercing hole is prevented in a reliable manner.

The first gas flow quickly removes the melt and slag and thereby facilitates the piercing operation. However, it is problematic when using only one gas flow that the hot melt which is washed from the piercing hole subsequently solidifies again directly on the workpiece and becomes bonded thereto. Because of the second gas flow, which is directed transversely, that is to say, in an inclined or lateral manner relative to the first gas flow, the melt is removed from the workpiece and the connection between the melt and the workpiece is thereby prevented. In addition, the slag is cooled and redirected by the second gas flow, which results in the slag no longer having sufficient energy to melt the material and thereby become adhesively bonded to the workpiece when it later strikes the workpiece. There are therefore produced only beads of slag, which are not disruptive during the subsequent separation processing operation.

In an advantageous variant, the second gas flow has a substantially rectangular cross-section shape for producing a flat cushion of gas on the workpiece. The production of a flat gas cushion which is as wide as possible on the workpiece is advantageous for preventing the slag from being removed too far from the workpiece and potentially becoming adhesively bonded to the lower side of a laser processing head, which focuses the laser beam on the piercing location.

During the piercing operation, a flow of cutting gas which in particular contains oxygen, is preferably directed onto the piercing location of the laser beam. For the piercing operation, particularly with relatively large sheet thicknesses, it is advantageous to use oxygen as a piercing gas (cutting gas) since this provides additional energy for the piercing operation.

In a preferred variant, a third gas flow extends above the second gas flow, preferably perpendicularly relative to the laser beam axis, in order to keep the discharged slag away from a laser processing head which is positioned above the third gas flow. The third gas flow, which can be configured, for example, as a flat gas curtain, and/or can extend around a cutting gas nozzle provided on the laser processing head, serves to prevent the slag blown away by the first gas flow from becoming deposited on the lower side of the laser processing head. Owing to the combination of the three gas flows, it is consequently possible to ensure controlled and defined removal of the slag during the piercing process.

Advantageously, the second gas flow contains a non-flammable gas or fluid, preferably compressed air, nitrogen or a gas/water mixture for producing a gas/water mist. The first and/or the third gas flow preferably contain(s) nitrogen or compressed air. These gas flows, in contrast to the cutting gas flow, are not intended to undergo any chemical reaction with the workpiece material during the piercing operation. A typical pressure range for the second gas flow is for the present application using compressed air approximately 4 bar. The cutting gas flow, when using oxygen as a cutting gas, typically has a pressure of approximately 3 bar.

Preferably, the first angle is selected to be between 110° and 160° and/or the second angle is selected to be between 110° and 150°, in particular between 115° and 130°. With appropriate determination of the first angle, it is possible to convey the slag away from the piercing location in a particularly effective manner. In this instance, the second angle must be selected in such a manner that the second gas flow does not strike the workpiece too steeply in order to prevent a situation in which, instead of a gas cushion being produced, the opposite effect occurs, that is to say, the slag is pressed down onto the workpiece.

In an advantageous embodiment, the second gas nozzle, for producing a second gas flow with a substantially rectangular cross-section shape, has a slot-like nozzle opening in order to produce a flat gas cushion on the workpiece. Of course, it is also possible to use gas nozzles with different outlet geometries, for example, circular or elliptical geometries. In some cases a plurality of second gas nozzles are used in order to produce a gas cushion which is as wide as possible.

In a particularly advantageous embodiment, the laser processing head has a third gas nozzle for producing the third gas flow, which is preferably orientated perpendicularly relative to the laser beam direction and which extends above the second gas flow, in order to keep the discharged slag away from the laser processing head. In this manner, it is possible to effectively prevent the slag which has been lifted by the gas cushion produced by the second gas flow from being able to become attached to the lower side of the laser processing head. In addition or as an alternative to the third gas flow, a collar-like, for example, frusto-conical, splash protection may be fitted to the lower side of the laser processing head.

In another advantageous embodiment, the laser processing head has at least two second gas nozzles that are arranged adjacent to each other and oriented in a parallel manner, for producing a wide and flat gas cushion on the workpiece.

In a particularly preferred embodiment, a nozzle opening of the second gas nozzle is arranged with a spacing of between 10 mm and 20 mm from the nozzle axis of the laser cutting nozzle. In this case, the nozzle opening of the second gas nozzle is typically not in the region of the first gas flow but is arranged offset therefrom, so that the second transverse gas flow can extend over the entire width of the first gas flow.

Other advantages of the invention will be appreciated from the description and the drawings. The features set out above and those mentioned in greater detail below can also be used individually or together in any combination. The embodiments illustrated and described are not intended to be understood to be a definitive listing, but instead are of an exemplary nature to describe the invention.

### DESCRIPTION OF DRAWINGS

FIGS. 1a and 1b are two schematic illustrations of an embodiment of a laser processing head according to the invention, when viewed in the X and Y direction, respectively and

FIGS. 2a-2e are schematic illustrations of first and second additional gas flows with associated gas nozzles for piercing a workpiece.

### DETAILED DESCRIPTION

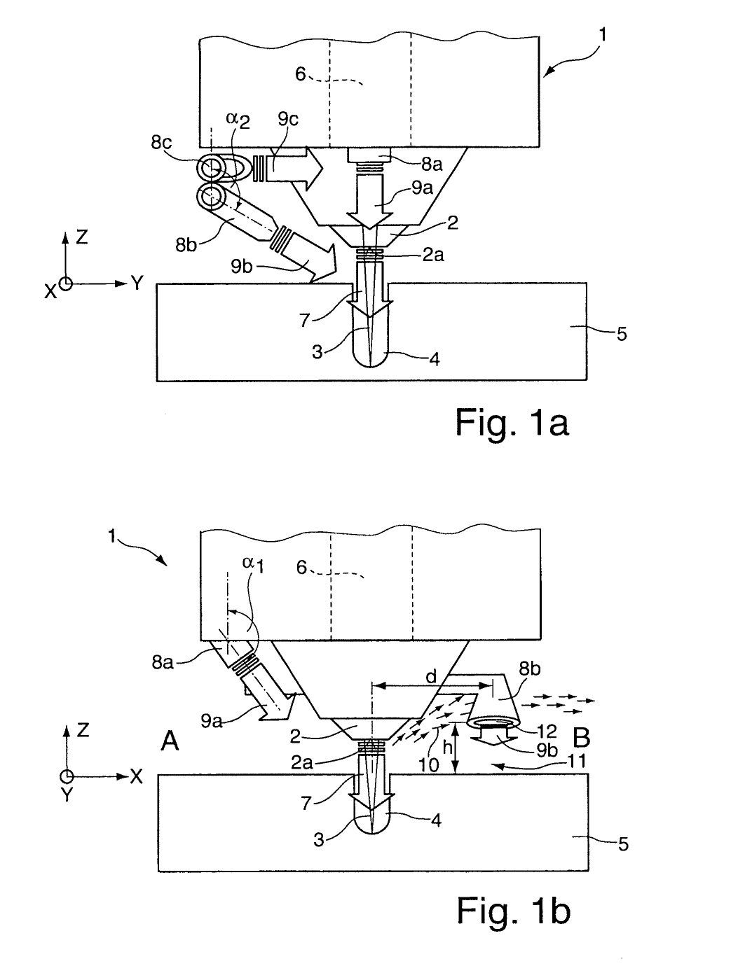

FIGS. 1a and 1b are side views of a laser processing head 1 along the X axis and the Y axis of an XYZ co-ordinate system, respectively. The laser processing head 1 has a laser cutting nozzle 2, through the nozzle opening 2a of which there extends a laser beam 3 which produces a piercing location 4 (piercing hole) on a workpiece 5. The laser cutting nozzle 2 is further connected to a pressure space 6 of the laser processing head 1 that is filled with a cutting gas, in particular oxygen, in order to direct a flow of cutting gas 7 through the nozzle opening 2a onto the piercing location 4.

A first gas nozzle 8a is arranged on the laser processing head 1 at a first side A (cf. FIG. 1b) of the laser cutting nozzle 2 approximately 40 mm from the piercing location 4 in order to produce a first additional gas flow 9a which strikes the workpiece 5 at the first side A of the piercing location 4 in order to blow slag 10 away from the piercing location 4. In this instance, the additional gas flow 9a and the gas nozzle 8a are oriented at a first angle α1 relative to the laser beam axis Z, which is typically in a range of between 110° and 160° in order to blow the slag 10 away from the piercing location 4 in the most effective manner possible.

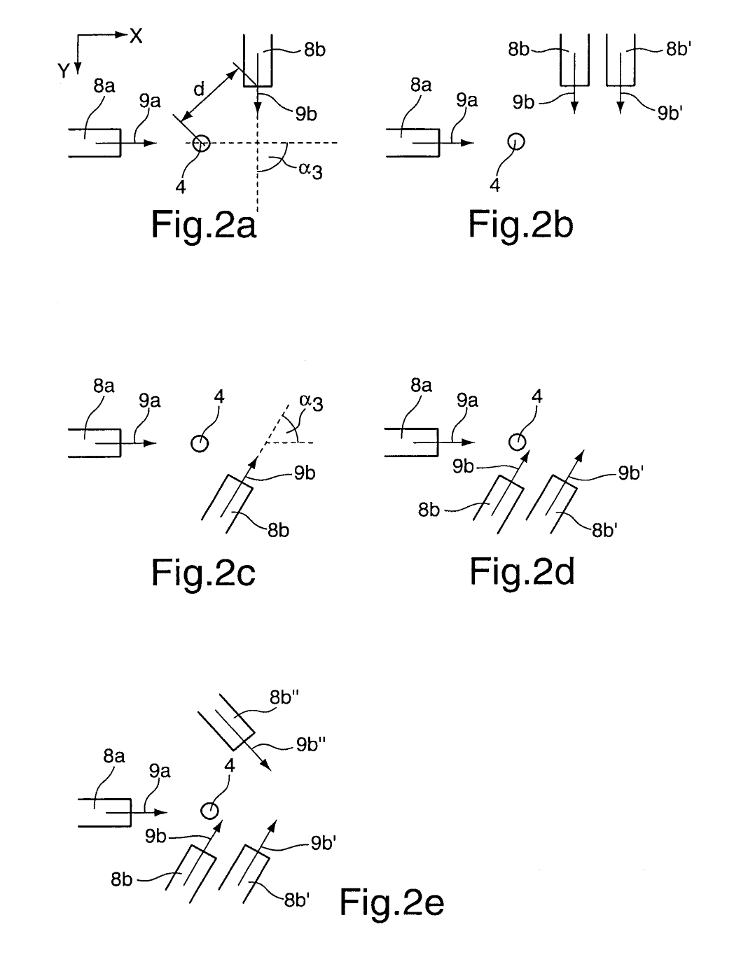

In order to prevent the slag 10 that is cleaned by the first additional gas flow 9a from the piercing hole or the piercing location 4 from hardening again on the workpiece 5 at an opposite side B of the laser cutting nozzle 2 and becoming bonded thereto, there is fitted to the laser processing head 1a second gas nozzle 8b which produces a second additional gas flow 9b which strikes the workpiece 5 approximately 20 mm away from the piercing location 4. As can be better seen in FIG. 2a, in which the XY plane is illustrated perpendicularly relative to the laser beam direction Z, the second additional gas flow 9b is oriented in the projection in the XY plane transversely or perpendicularly relative to the first additional gas flow 9a. In this case, the second gas nozzle 8b is spaced apart by approximately 15 mm or more from the centre of the piercing location 4, which corresponds to the centre of the nozzle opening 2a. The second additional gas flow 9b extends, as can be seen in FIG. 1a, relative to the laser beam direction Z at a second angle α2 of approximately 120°. The second angle α2 is flat enough for the second additional gas flow 9b to produce a gas cushion 11 between the workpiece 5 and the slag 10 blown away by the first additional gas flow 9a. The angular range at which the second additional gas flow 9b is intended to extend relative to the laser beam direction Z so that the gas cushion 11 is produced, is typically between approximately 110° and 150°, in particular between 115° and 130°.

In order to prevent the slag 10 lifted from the workpiece 5 by the second additional gas flow 9b from reaching the lower side of the laser processing head 1 and becoming attached thereto, a third gas nozzle 8c is fitted to the laser processing head 1 at the second side B of the laser cutting nozzle 2, in order to produce a third additional gas flow 9c. In contrast to the first and second additional gas flow 9a, 9b, the third additional gas flow 9c is not directed onto the workpiece 5 but instead extends perpendicularly relative to the laser beam direction Z above the second additional gas flow 9b and around the laser cutting nozzle 2, in order to protect the laser processing head 1 from the slag 10. Owing to the combination of the three additional gas flows 9a-c, it is consequently possible to ensure controlled and defined removal of the slag 10 from the piercing location 5.

The first additional gas flow 9a may contain nitrogen and/or compressed air, the second and third additional gas flow 9b, 9c typically contain a non-flammable gas, generally also compressed air or nitrogen. If compressed air is used, in the present application, it typically has a pressure in the order of magnitude of 4 bar. The second additional gas flow 9b may also have a liquid portion, for example, with water being mixed with the non-flammable gas, in order to form a gas/water mist that has an additional cooling effect on the slag 10 in order to convert it into spherical beads of molten material that do not disrupt the subsequent separation process.

The gas cushion 11 should be constructed so as to be as flat and as wide as possible. To this end, the second gas nozzle 8b may have a slot-like nozzle opening 12 as illustrated in FIG. 1b and that is positioned at a height h of approximately 10 mm above the workpiece 5. Of course, in order to produce a gas cushion 11 as wide as possible, it is also possible to arrange, adjacent with the second gas nozzle 8b, a further second gas nozzle 8b′ oriented parallel therewith, in order to produce a further second additional gas flow 9b′ as illustrated in FIG. 2b. The further second additional gas flow 9b′ joins the first additional gas flow 9 on the workpiece 5 in this instance.

It is evident that the second additional gas flow 9b or the second additional gas flows 9b, 9b′ do not necessarily have to be oriented perpendicularly relative to the first additional gas flow 9a, but instead the second additional gas flows 9b, 9b′ can be oriented at an angle α3 of between approximately 30° and approximately 135° relative to the first additional gas flow 9a, as shown by way of example in FIGS. 2c and 2d, using an angle of approximately 80°. Orientation at an angle of 90° or less has been found to be particularly advantageous, that is to say, at angles at which the second additional gas flow 9b, 9b′ does not have a flow component directed towards the first additional gas flow 9a.

As can be seen in FIG. 2e, when a plurality of second additional gas flows are used, they do not necessarily have to be oriented in a parallel manner. Instead, it is also possible to fit to the laser processing head 1 an additional second gas nozzle 8b″ that produces a further second additional gas flow 9b″ which has a flow component in a positive Y direction directed counter to the second additional gas flows 9b, 9b′ of FIG. 2d.

In conclusion, owing to the use of second additional gas flows 9b, 9b′, 9b″ that produce a gas cushion 11, it is possible to substantially reduce the accumulation of slag beside the piercing location 4 and the cutting processing operation that follows the piercing operation can also be readily carried out after the piercing operation using the two or three additional gas flows 9a, 9b, 9b′, 9b″, 9c, even for producing components with small internal geometries.

A number of embodiments of the invention have been described. Nevertheless, it will be understood that various modifications may be made without departing from the spirit and scope of the invention. Accordingly, other embodiments are within the scope of the following claims.

What is claimed is:

1. A method of piercing a workpiece with a laser beam, the method comprising
directing a laser beam onto the workpiece at a piercing location;
directing a first gas flow onto the workpiece at a first angle relative to the laser beam, the first gas flow striking the workpiece at a location selected to cause the first gas flow to blow slag away from the piercing location; and
directing a second gas flow onto the workpiece at a second angle relative to the laser beam, the second gas flow striking the workpiece at a position spaced from the piercing location, the second gas flow being oriented at an angle relative to the first gas flow with respect to a plane perpendicular to the laser beam, the second gas flow producing a gas cushion between the workpiece and slag blown away from the piercing location by the first gas flow.

2. The method of claim 1, wherein the second gas flow is oriented at an angle of between 30 and 135 degrees, relative to the first gas flow.

3. The method of claim 2, wherein the second gas flow is oriented at an angle of between 45 and 100 degrees, relative to the first gas flow.

4. The method of claim 1, wherein the second gas flow has a substantially rectangular cross-sectional shape, the second gas flow producing a flat gas cushion on the workpiece.

5. The method of claim 1, further comprising directing a flow of cutting gas, separate from the first and second gas flows, onto the piercing location.

6. The method of claim 5, wherein the cutting gas comprises oxygen.

7. The method of claim 1, further comprising directing a third gas flow to extend between the second gas flow and a laser processing head, the third gas flow keeping the discharged slag away from the laser processing head.

8. The method of claim 7, wherein the third gas flow is directed to extend perpendicular to the laser beam.

9. The method of claim 7, wherein at least one of the first and third gas flows contains nitrogen.

10. The method of claim 1, wherein the first angle is between 110 and 160 degrees.

11. The method of claim 1, wherein the second angle is between 115 and 130 degrees.

12. A laser processing head comprising:
a laser cutting nozzle connected to both a laser beam source and a cutting gas source, the cutting nozzle defining a laser beam axis and positioned to direct a laser beam and a flow of cutting gas onto a workpiece at a piercing location;
a first gas nozzle, disposed on a first side of the laser cutting nozzle and oriented at a first angle relative to the laser beam axis, the first gas nozzle positioned to direct a first gas flow to strike the workpiece at a location selected to cause the first gas flow to blow slag away from the piercing location; and
a second gas nozzle, disposed on a second side of the laser cutting nozzle and oriented at a second angle relative to the laser beam axis, the second gas nozzle positioned to direct a second gas flow oriented at an angle relative to the first gas flow with respect to a plane perpendicular to the laser beam axis, to strike the workpiece at a location spaced from the piercing location and produce a gas cushion between the workpiece and slag blown away by the first additional gas flow.

13. The laser processing head of claim 12, wherein the first gas nozzle and the second gas nozzle are oriented to cause the first gas flow and the second gas flow to define an angle of between 30 and 135 degrees with respect to a plane perpendicular to the laser beam axis.

14. The laser processing head of claim 12, wherein the second gas nozzle has a slot-like nozzle opening, so as to produce a gas flow with a substantially rectangular cross-section.

15. The laser processing head of claim 12, further comprising a third gas nozzle positioned to direct a third gas flow between the laser processing head and the second gas flow, to keep the discharged slag away from the laser processing head.

16. The laser processing head of claim 15, wherein the third gas nozzle is positioned to direct the third gas flow perpendicular to the laser beam axis.

17. The laser processing head of claim 12, wherein the first angle is between 110 and 160 degrees and the second angle is between 115 and 130 degrees.

18. The laser processing head of claim 12, comprising at least two second gas nozzles positioned adjacent to each other and oriented to produce parallel gas flows.

19. The laser processing head of claim 12, wherein the second gas nozzle has a nozzle opening spaced between 10 mm and 20 mm from a nozzle opening of the laser cutting nozzle.
